(19) United States
(12) Patent Application Publication
(10) Pub. No.: US 2013/0057760 A1
(43) Pub. Date: Mar. 7, 2013

(54) SOURCE TERMINAL AND METHOD FOR OUTPUTTING DATA TO EXTERNAL OUTPUT DEVICE

(71) Applicant: Chang-Yong LEE, Seoul (KR)

(72) Inventor: Chang-Yong LEE, Seoul (KR)

(73) Assignee: Pantech Co., Ltd., Seoul (KR)

(21) Appl. No.: 13/452,319

(22) Filed: Apr. 20, 2012

(30) Foreign Application Priority Data
Sep. 5, 2011 (KR) 10-2011-0089860

(51) Int. Cl. H04N 5/38; H04N 11/06; H04N 9/64

(52) U.S. Cl. 348/474; 348/723; 348/720; 348/E05.093; 348/E09.037; 348/E11.007

(57) ABSTRACT

A source terminal to output audio and video data to an external output device acquires and stores connection information during a connection to the external output device, in which the connection information may be stored for a future connection to the same external output device. Also, the source device may configure audio and video data to be transmitted to the external output device using the stored connection information, and transmit the configured audio and video data to the external output device. A method for connecting to the external output device includes detecting a connection between a source terminal and an external output device, determining whether connection information of the external output device is stored in the source terminal, retrieving connection information of the external output device, configuring audio and video data for the external output device using the connection information, and transmitting the configured data to the external output device.

### CROSS-REFERENCE TO RELATED APPLICATION

This application claims priority from and the benefit under 35 U.S.C. §119(a) of a Korean Patent Application No. 10-2011-0089860, filed on Sep. 5, 2011, which is hereby incorporated by reference for all purposes as if fully set forth herein.

### BACKGROUND

1. Field

The following description relates to an audio and video output technology, and more particularly, to an audio and video output technology using a communication connection between a source terminal and an external output device.

2. Discussion of the Background

An image viewed in a source terminal, such as a mobile phone, may also be viewed in an audio/video (A/V) display device, such as a television, over an external interface. A high-definition multimedia interface (HDMI) as an external interface can relay high-performance video and audio signals. There is a set-top box that supports HDMI.

In use of the external interface including HDMI, the source terminal may read out data from memory of an A/V display device if the source terminal is connected to the A/V display device. Further, the source terminal may also analyze the read data, and reconfigure the video and audio according to an analysis result. This may cause a delay in time to configure the external output device to correspond to the source terminal. A delay may occur in a home set-top box, television (TV) connection, and the like. Further, a delay may increase as the amount of data to be read and analyzed increases with the growing introduction of advanced display devices, such as TV, that may be compatible with 3-dimensional (3-D) technology or the like.

Korean Patent Application No. 10-2010-0056013 discloses a technology using extended display identification data (EDID) information to use the HDMI connection.

### SUMMARY

Exemplary embodiments of the present invention provide a source terminal to output audio and video data to an external output device and a method for connecting or outputting data to the external output device.

Additional features of the invention will be set forth in the description which follows, and in part will be apparent from the description, or may be learned by practice of the invention.

Exemplary embodiments of the present invention provide a source terminal including a storage unit to store connection information of an external output device, a control unit to configure audio and video data to be transmitted to the external output device using the connection information, and an output unit to transmit the audio and video data to the external output device.

Exemplary embodiments of the present invention provide a method for providing audio/video (A/V) data including detecting a connection between a source terminal and an external output device; determining whether connection information of the external output device is stored in the source terminal; retrieving connection information of the external output device; configuring audio and video data for the external output device using the connection information; and transmitting the audio and video data to the external output device.

Exemplary embodiments of the present invention provide a method for storing extended display identification data (EDID) of an external output device including detecting a connection to the external output device; reading the EDID of the external output device; determining whether stored EDID corresponds to the read EDID; parsing EDID data, if the read EDID does not correspond to the stored EDID; performing audio and video configuration based on the parsed EDID data; and storing the EDID data.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a connection between a source terminal and an external output device according to an exemplary embodiment of the present invention.

FIG. 2 is a diagram illustrating a source terminal according to an exemplary embodiment of the present invention.

FIG. 3 is a flowchart illustrating a method for acquiring and storing connection information at the first connection to an external output device according to an exemplary embodiment of the present invention.

FIG. 4 is a diagram illustrating an extended display identification data (EDID) format according to an exemplary embodiment of the present invention.

FIG. 5 is a flowchart illustrating a method for determining whether a cable-connected external output device has been previously connected and transmitting audio and video based on the determination result according to an exemplary embodiment of the present invention.

FIG. 6 is a flowchart illustrating a method for outputting audio and video data to a previously connected external output device according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

It will be understood that when an element is referred to as being “connected to” another element, it can be directly connected to the other element, or intervening elements may be present.

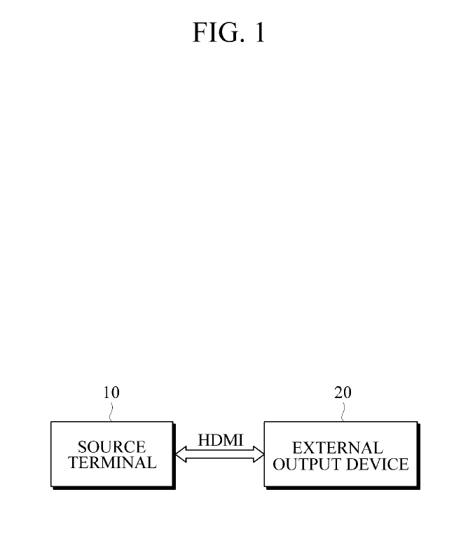

FIG. 1 is a diagram illustrating a connection between a source terminal and an external output device according to an exemplary embodiment of the present invention.

Referring to FIG. 1, source terminal 10 is connected to external output device 20 via a communication cable. The external output device 20 may output audio and/or video data. Once connected, the source terminal 10 may transmit audio and/or video data to the external output device 20, which may output the received data. The external output device 20 may be a television. The communication cable may be a high-definition multimedia interface (HDMI) as shown in FIG. 1. The HDMI may be a more advanced interface compared to digital visual interface (DVI). DVI may transmit digital video only, whereas HDMI may transmit digital video, digital audio and/or additional information to the external output device 20 through a single interface. Hereinafter, for convenience of explanation, the communication cable will be described as HDMI, but is not limited as such.

A source terminal may read extended display identification data (hereinafter, referred to as ‘EDID data’) present in the memory of the external output device if the source terminal is connected to the external output device. Further, the source terminal may also check the validity of the read EDID data. Then, the EDID data may be parsed, and video and audio data may be configured based on the parsed information to generate an auxiliary video information (AVI) infoframe. Thereafter, the video and audio data may be transmitted to the external output device, and outputted by the external output device. The EDID data may refer to data related to a type of video format and other information supported by the external output device. The source terminal may read the EDID data to determine and transmit video compatible with the external output device.

The aforementioned process may be repeatedly performed for each connection between the source terminal and the external output device. Thus, it may provide some delay in time for the video and audio data to be reproduced by the external output device after the external output device is connected via the cable. Furthermore, in consideration of the features that may be provided by the external output device, such as a 3-dimension (3D) technology support, the amount of data to be read and parsed by the source terminal may be increased.

Hereinafter, a technology to reduce a delay in time to provide video and/or audio data by the external output device 20 is described in more detail.

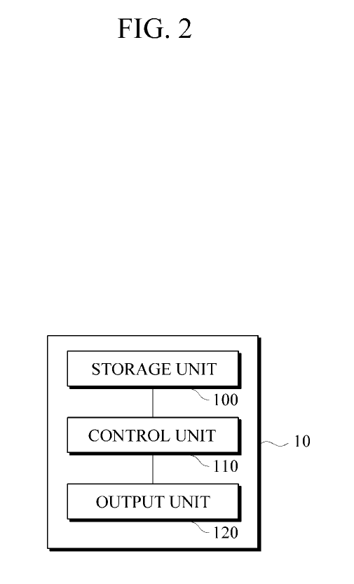

FIG. 2 is a diagram illustrating a source terminal according to an exemplary embodiment of the present invention.

Referring to FIG. 1 and FIG. 2, source terminal 10 may include a storage unit 100, a control unit 110, and an output unit 120.

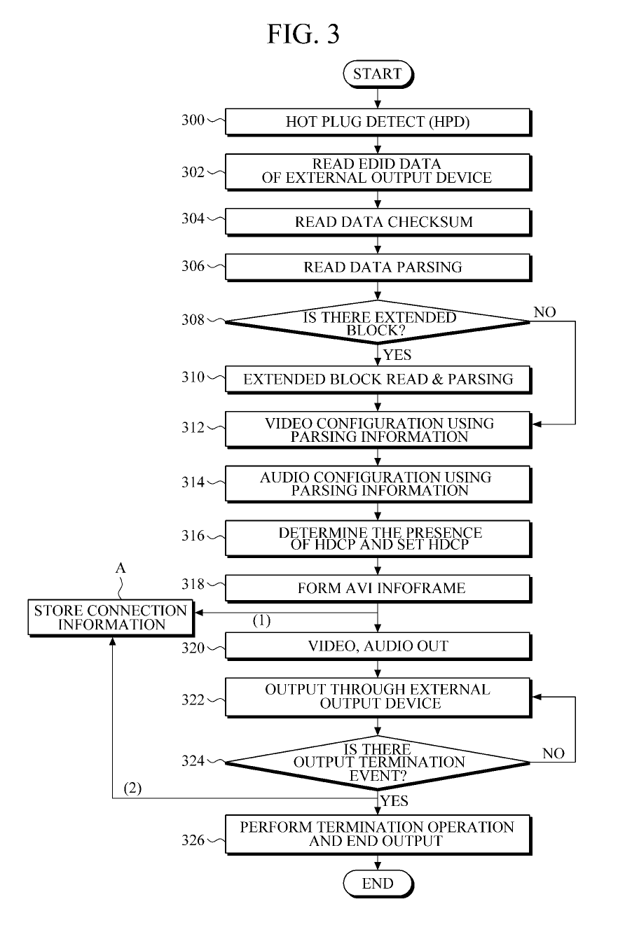

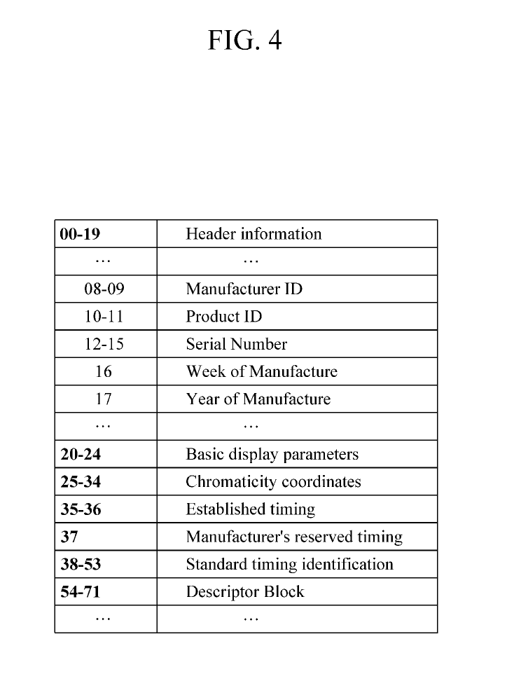

The storage unit 100 may acquire and/or store connection information of the external output device 20 during a first connection to the external output device 20. The connection information may be stored and used in the future connection to the same or similar external output device 20. For the purposes of this specification, a similar external output device may refer to other external output devices with similar specifications or complying with similar or compatible standards. The connection information may include at least one of determination information to determine whether the external output device 20 has been connected before to the source terminal 10, and output information to support the output to the external output device 20. The determination information may include at least one of manufacturer information, product information and serial number information of the external output device 20. The determination information and the output information may be acquired from EDID data, EDID parsing information and auxiliary video information, which may be captured during the first connection between the source terminal 10 and the external output device 20. The auxiliary video information may include AVI infoframe. More detailed description of the connection information including the determination information and the output information is described below with reference to FIG. 3. More detailed description of the EDID data is described below with reference to FIG. 4.

Once the source terminal 10 is connected to the external output device 20, the control unit 110 may configure audio and video data to be transmitted to the external output device 20 using the connection information stored in the storage unit 100. The output unit 120 may transmit the audio and video data configured by the control unit 110 to the external output device 20 through a communication cable.

The control unit 110 may determine whether the connected external output device 20 has been connected before based on the connection information stored in the storage unit 100. The control unit 110 may read in the manufacturer information, the product information, and/or the serial number information from the external output device 20 for determination. Then, the control unit 100 further determines whether the connection information of the external output device 20 stored in the storage unit 100 includes information that corresponds to at least one of the manufacture, product, and serial number information of the external output device 20. If corresponding information in the connection information is identified, it may be determined that the external output device 20 has been connected before.

If the external output device 20 is determined to have been connected to the source terminal 10 before, audio and video data may be configured using results of operations performed during the previous connection, including EDID data read, read data parsing, extended block read and configuration of audio and video data. If the external output device 20 is determined to be connected to the source terminal 10 for the first time, audio data and video data configuration may be acquired and stored for future use.

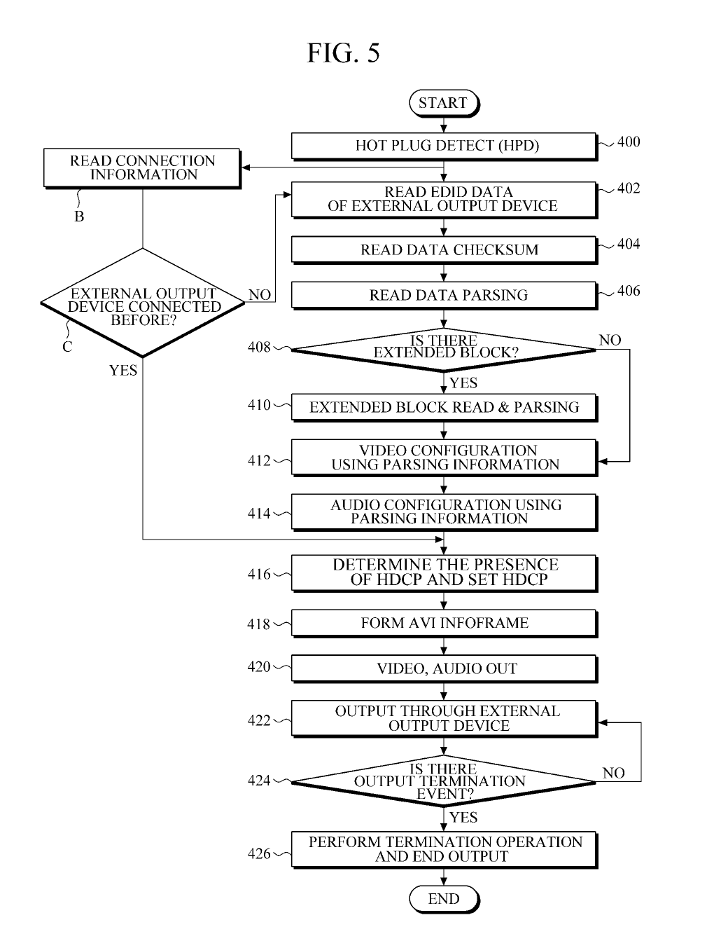

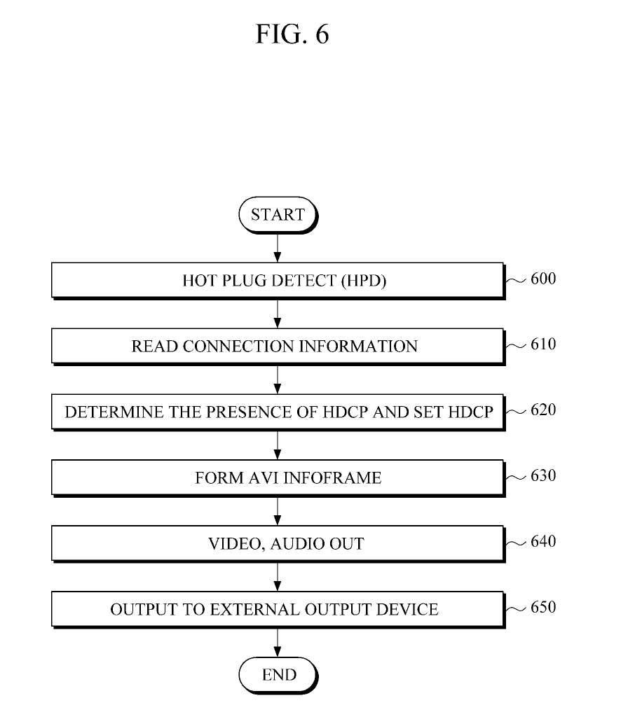

FIG. 3 is a flowchart illustrating a method for acquiring and storing connection information at the first connection to an external output device according to an exemplary embodiment of the present invention. The methods of FIG. 3, FIG. 5, and FIG. 6 below will be described as if performed by the source terminal connected to external output device as shown in FIG. 1, but are not limited as such.

Referring to FIG. 1, FIG. 2, and FIG. 3, the source terminal 10 detects cable connection to an external output device 20 in operation 300 (i.e., Hot Plug Detect: HPD). If the cable connection is detected, EDID data is read in from memory of the external output device 20 in operation 302. The source terminal 10 may determine whether to read the EDID data from the external output device 20 in operation 304, and parses the read EDID data in operation 306 if the EDID data from the external output device 20 is read. It will be assumed that the EDID data is read from the external output device 20 in operation 304. In an example, if the connection information read from the external output device 20 does not correspond to the stored connection information, the EDID data may be read from the external output device 20.

The source terminal 10 determines whether an extended data block is present in operation 308, and if the extended data block is present, the source terminal 10 reads in the extended data block and parses the read data block in operation 310. If extended data block is not present, the method proceeds to operation 312. Based on the parsed data block and the determination extended data block is present, video configuration and audio configurations are performed, respectively, in operation 312 and operation 314. Based on the presence of high-bandwidth digital content protection (HDCP), a chip with HDCP performs an HDCP-related operation in operation 316. The source terminal 10 configures AVI infoframe in operation 318, and transmits the video and audio data to the external output device 20 in operation 320, and thereby the external output device 20 can output the video and audio data in operation 322. If a termination event, such as an end key or cable disconnection, occurs during outputting the audio and video data in operation 324, the connection is terminated in operation 326. If no such terminal event occurs, the external output device 20 may continually output the video and audio data in operation 322.

In operation A, the source terminal 10 acquires and stores connection information of the external output device 20, in which the connection information may be used for future connection to the same external output device. The connection information of the external output device 20 may be acquired and stored during a first connection with the external output device 20, and may be updated during a subsequent connection if changes or updates are made to the external output device 20. The connection data of the external output device 20 may be acquired and/or stored during a period between when the video and audio transmission to the external output device 20 starts (represented by arrow (1) in FIG. 3) and when the video and audio transmission to the external output device 20 ends (represented by arrow (2) in FIG. 3). Further, if the source device 10 remains connected to the external output device 20 via the cable and is available to read the EDID data from the external output device 20, the connection information can be stored after finishing outputting the video and audio, such as after operation 326 (not shown).

The above examples show the timing of storing the connection information and how to store the connection information to be used for the next connection, which may be used to build and manage a database containing such information. The connection information may include at least one of determination information, which may be used to determine whether the external output device has been connected before, and output information, which may be used to support the output to the external output device.

The determination information may be obtained from the 8th to 16th byte information of EDID format, and may include at least one of a manufacturer identification (ID), a product ID, serial number, and manufacture-date information (e.g., manufactured year, week, date). If a product ID has been accurately assigned to a product by a manufacturer and there is a connection history regarding a particular product, the same group of products having the product ID may be recognized by the source terminal 10 and may reduce a delay at the initial connection. For example, if a home TV is the same or has similar specifications as a neighbor's TV, the source terminal that has been connected to the home TV before may be able to output audio and video data to the neighbor's TV with a reduced delay even upon the first-time connection to the neighbor's TV by referring to the stored connection information associated with the home TV.

Output information may include at least one of video information conversion compatibility (e.g., YCbCr 4:4:4, 4:2:2, 4:2:0), deep color support (e.g., 36 bit deep color support), Dolby® True HD compatibility, 3 dimensional (3-D) support, audio compatible format, audio sampling frequency, the number of channels supporting audio, the number of used bits in linear pulse-code modulation (LPCM), available resolution, and hertz (Hz) information. The audio format compatibility may include compatibility with Arc Consistency Algorithm 3 (AC-3), Advance Audio Coding (AAC), Transport Stream (TS), Moving Picture Experts Group (MPEG)-1 or MPEG-2 Audio Layer III (MP3), LPCM, or the like. The output information may reduce a delay during the subsequent connections to the external output device, and video and audio signals may be output based on the output information.

Storing and managing the connection information as a database may vary according to software configuration of each source terminal or a structure of a user interface (UI).

FIG. 4 is a diagram illustrating an EDID format according to an exemplary embodiment of the present invention.

Referring to FIG. 4, EDID may refer to a standard to transmit display information from an external output device to a source terminal, which may specify a data format of display capability that may be transmitted.

As shown in FIG. 4, the 8th to 9th bytes of the EDID format are assigned to indicate a manufacture ID, and the 10th to 11th bytes are assigned to indicate a product ID. The 12th to 15th bytes are assigned to indicate a serial number, the 16th byte is assigned to indicate a week of manufacture and the 17th byte is assigned to indicate a year of manufacture.

The 20th and subsequent bytes indicate the output information including the output capability of the external output device. The output information may include at least one of timing-related information, video conversion compatibility (e.g., YCbCr 4:4:4 or 4:2:2), deep color support, Dolby® True HD compatibility, 3-D compatibility, audio format compatibility, audio sampling frequency, the number of channels supporting audio, the number of used bits in LPCM, available resolution, and hertz (Hz) information. The audio format compatibility may include compatibility with AC-3, AAC, TS, MP3, LPCM, or the like. The types of output information may include future developments of the external output device and future standards for output information.

FIG. 5 is a flowchart illustrating a method for determining whether a cable-connected external output device has been previously connected and transmitting audio and video based on the determination result according to an exemplary embodiment of the present invention.

Referring to FIG. 1, FIG. 2, FIG. 3, FIG. 4, and FIG. 5, after detecting a connection in operation 400, the source terminal 10 reads connection information in operation B and reads EDID data of the external output device 20 in operation 402. The connection information of the external output device 20 may be read prior to, simultaneously, or subsequent to reading EDID data. The source terminal 10 determines whether the external output device 10 has been connected to the source terminal 10 before based on the connection information in operation C. The source terminal 10 may read in manufacturer information, product information, and/or serial number information from the external output device 20, and checks to determine whether the previously stored connection information of the external output device has the same or similar information as the read-in information. If the corresponding information is found in the previously stored connection information, it may be determined that the external output device has been connected before.

If the external output device is determined as having been connected before, EDID data and parsing results, extended block read and parsing results, and video and audio configuration results may already be obtained as described with reference to FIG. 3, and thus the source terminal 10 may perform operations 416, 418, 420, 422, 424, and 426 that follow the video and audio configuration operations 412 and 414.

If it is determined that the external output device has not been connected to the source device before, EDID data read and parsing operations 402, 404, and 406, extended block read and parsing operations 408 and 410, and video and audio configuration operations 412 and 414 are performed.

A source device of a typical user may be connected to a new output device at time of connection, or be connected to the same or similar external output device that has been connected before.

FIG. 6 is a flowchart illustrating a method for outputting audio and video data to a previously connected external output device according to an exemplary embodiment of the present invention.

Referring to FIG. 1, FIG. 2, FIG. 3, FIG. 4, FIG. 5 and FIG. 6, a delay time in EDID read and parsing, extended block read and parsing, and video and audio configuration may be reduced if the cable connection between the source terminal 10 and the external output device 20 with stored connection information is established. Delay in time during the connection may occur in the aforementioned operations. The source terminal 10 may reduce the aforementioned delay time by using the stored data, thereby being able to output video and audio data to the external output device after the cable detection operation 600. That is, as shown in FIG. 6, if it is determined that the external output device 20 has been connected to the source device 10 before by reading connection information in operation 610, determination and set of the presence of HDCP in operation 620, AVI infoframe configuration in operation 630, video and audio data transmission in operation 640, and output of the video and audio data to the external output device 620 in operation 650 are performed. One or more of EDID read and parsing operations, extended block read and parsing operations, and video and audio configuration operations may be omitted, which may reduce the process time.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A source terminal, comprising:
a storage unit to store connection information of an external output device;
a control unit to configure audio and video data to be transmitted to the external output device using the connection information; and
an output unit to transmit the audio and video data to the external output device.

2. The source terminal of claim 1, wherein the connection information comprises at least one of determination information to indicate that the external output device has been connected before to the source terminal, and output information to support the output to the external output device.

3. The source terminal of claim 1, wherein the connection information comprises at least one of manufacturer information, product information, and serial number information of the external output device.

4. The source terminal of claim 1, wherein the connection information is acquired from extended display identification data (EDID) data, EDID parsing information, and auxiliary video information.

5. The source terminal of claim 4, wherein the connection information is captured during a connection between the source terminal and the external output device.

6. The source terminal of claim 2, wherein output information comprises at least one of video information conversion compatibility, deep color support, Dolby® True HD compatibility, 3-dimensional (3-D) support, audio compatible format, audio sampling frequency, the number of channels supporting audio, the number of used bits in LPCM, available resolution, and hertz (Hz) information.

7. The source terminal of claim 2, wherein the control unit reads in first determination information from the external output device, and compares the first determination information with second determination information stored in the storage unit to determine whether the external output device has been previously connected to the source terminal.

8. The source terminal of claim 7, wherein if the control unit determines that the external output device has been previously connected, the source terminal uses an audio and video configuration from the previous connection.

9. The source terminal of claim 1, wherein the source terminal and the external output device are connected by a high-definition multimedia interface (HDMI) cable.

10. The source terminal of claim 1, wherein the stored connection information of the external output device is used to configure audio and video data of a different external output device.

11. A method for providing audio/video (A/V) data, comprising:
detecting a connection between a source terminal and an external output device;
determining whether connection information of the external output device is stored in the source terminal;
retrieving connection information of the external output device;
configuring audio and video data for the external output device using the connection information; and
transmitting the audio and video data to the external output device.

12. The method of claim 11, wherein the connection information comprises at least one of determination information to indicate that the external output device has been connected before to the source terminal, and output information to support the output to the external output device.

13. The method of claim 12, wherein the determination information comprises at least one of manufacturer information, product information, and serial number information of the external output device.

14. The method of claim 12, wherein the determination information and the output information are acquired from extended display identification data (EDID) data, EDID parsing information, and auxiliary video information.

15. The method of claim 14, wherein the connection information is captured during a connection between the source terminal and the external output device.

16. The method of claim 12, wherein output information comprises at least one of video information conversion compatibility, deep color support, Dolby® True HD compatibility, 3-dimensional (3-D) support, audio compatible format, audio sampling frequency, the number of channels supporting audio, the number of used bits in LPCM, available resolution, and hertz (Hz) information.

17. The method of claim 12, wherein determining whether connection information of the external output device exists comprises:
reading in first determination information from the external device; and
comparing the first determination information against second determination information stored in the source terminal.

18. The method of claim 17, audio and video configuration from the previous connection is used to transmit the audio and video data to the external output device in response to a determination that connection information of the external output device exists.

19. The method of claim 11, further comprising using the stored connection information of the external output device for configuring audio and video data for a different external output device.

20. A method for storing extended display identification data (EDID) of an external output device, comprising:
detecting a connection to the external output device;
reading the EDID of the external output device;
determining whether stored EDID corresponds to the read EDID;
parsing the read EDID data, if the read EDID does not correspond to the stored EDID;
performing audio and video configuration based on the parsed EDID data; and
storing the EDID data.
